(19) United States
(12) Patent Application Publication
(10) Pub. No.: US 2026/0211171 A1
(43) Pub. Date: Jul. 23, 2026

(54) LIGHT MODULE COMPRISING A LIGHT GUIDE WITH A GUIDE SHEET FOR A HOMOGENOUS LIGHT INTENSITY DISPLAY

(71) Applicant: VALEO VISION, Bobigny (FR)

(72) Inventors: Rabih TALEB, Bobigny (FR); Shivi SINGH, Bobigny (FR); Pierre-Louis TASSY, Bobigny (FR); Ghani SBIHI, Bobigny (FR)

(73) Assignee: VALEO VISION, Bobigny (FR)

(21) Appl. No.: 19/142,468

(22) PCT Filed: Dec. 19, 2023
(86) PCT No.: PCT/EP2023/086767

§ 371 Date: Jun. 23, 2025

(30) Foreign Application Priority Data
Dec. 23, 2022 (FR) FR2214461

(51) Int. Cl. F21V 8/00

(52) U.S. Cl. CPC G02B 6/0028; G02B 6/0036; G02B 6/006; G02B 6/0061

(57) ABSTRACT

The present invention relates to a light module. The light module includes a light guide with a light guide sheet and a light injection assembly, and a light source that is arranged so as to inject light rays into the entry surface of the at least one injection assembly. The guide sheet include a film with a light extraction region with microstructures capable of redirecting the light injected into the guide sheet toward the outside of the light module. The film includes microstructures on a first face and on a second face. For each portion from among portions of the light extraction region that are at different distances from a light injection edge surface, a sum of a density of microstructures on the first face and on the second face is an increasing function of the distance between the portion and the injection edge surface.

### TECHNICAL FIELD

The present invention relates to the field of luminous modules in which a light guide is employed, and in particular to luminous modules in which a flexible light guide is employed.

### BACKGROUND OF THE INVENTION

These days it is common practice for luminous functions to be performed in all sorts of different types of equipment, and in particular in automotive vehicle equipment, for the purposes of providing lighting, signaling information, achieving esthetic customization, or creating ambiance.

It is known practice to use displays such as LCDs.

However, this technology is not only expensive but also sensitive to environmental conditions, such as temperature, humidity or UV radiation. It is thus inappropriate for many pieces of equipment having uses that induce a variation in environmental conditions, as may be the case with equipment used outdoors.

Furthermore, the aforementioned solution has the disadvantage of high energy consumption, which is even higher the larger the surface area of the piece of equipment in which a luminous module is to be integrated.

It is known to use luminous modules with a light guide comprising a guiding sheet incorporating a film, which may be flexible, in which are guided light rays, which are steered into a given luminous pattern, depending on microstructures formed in the film. Light is injected into an injection edge of the film.

Whatever the technique used to form the microstructures in the light guide in order to produce the pattern, it is easier to produce the microstructures on the surface of the film, rather than in the bulk of the film.

The zones in which microstructures are created are light-extraction zones, while zones not comprising the microstructures are referred to as dark zones. The respective arrangements and shapes of the light-extraction zones and of the dark zones together form the luminous pattern of the light guide.

In order to achieve luminous uniformity between the light-extraction zones, provision may be made to vary the density of the microstructures in the light-extraction zones as a function of a distance from a light-injection edge of the film into which the light is injected.

However, the microstructure density in a light-extraction zone is limited by a maximum density. Such a maximum luminous density limits the size of the light guide for which a uniformity of the light-extraction zones may be obtained. The size may be increased, but in this case either the luminous intensity of the light guide must be limited or the uniformity in terms of luminous intensity is affected.

### SUMMARY OF THE INVENTION

There is thus a need to obtain a guiding-sheet-based luminous module for displaying a luminous pattern having a good luminous uniformity between the illuminated zones of the luminous pattern and having a large size.

The present invention improves the situation.

A first aspect of the invention relates to a luminous module comprising:
a light guide comprising a sheet for guiding light, the guiding sheet being configured to receive light rays via at least one light-injection edge, and to steer the light rays in a direction substantially normal to the guiding sheet, and at least one injecting assembly configured to receive light rays from an entrance surface and to guide the light rays so as to inject them into the light-injection edge of the guiding sheet;
a light source arranged so as to inject light rays into the entrance surface of the at least one injecting assembly.

The guiding sheet comprises a film, the film comprising at least one light-extraction zone comprising microstructures capable of redirecting the light injected into the guiding sheet at least in the substantially normal direction. The film comprises microstructures on a first side of the film and on a second side of the film. For each portion among portions of the light-extraction zone having different respective distances from the light-injection edge, a sum of a microstructure density on a first side in said portion and of a microstructure density on the second side in said portion, is an increasing function of the distance between said portion and the light-injection edge of the guiding sheet.

Increasing microstructure density as a function of distance from a light-injection position allows a display to be formed on the luminous module with a uniform distribution per unit area of the luminous intensity. A dynamic light-extraction range is thus defined by the variation in microstructure densities with increasing distance from the light-injection edge.

Forming microstructures on both sides of the film of the guiding sheet makes it possible to extract light from the light guide over a longer distance, while maintaining uniformity in the distribution per unit area of the luminous intensity in the light-extraction zone. It is thus possible to produce larger luminous modules. Alternatively, at equal size, it is possible to extract more light from the light guide, and therefore increase the brightness in the light-extraction zone, while allowing uniformity between the various portions of the light-extraction zone.

According to embodiments, the portions of the light-extraction zone may face a given section of the light-injection edge.

Such a section may correspond to a set of injection positions of an injecting element of the injecting assembly, when such an injecting assembly comprises a plurality of injecting elements capable of injecting light rays into distinct and consecutive sections of the light-injection edge. A dynamic light-extraction range is thus defined for each section, this allowing a good uniformity in the distribution of the luminous intensity between the various portions of said at least one light-extraction zone.

According to embodiments, a shape of said at least one light-extraction zone may form a luminous pattern of the luminous module.

This makes it possible to display a large luminous pattern with a good light-intensity uniformity.

According to embodiments, the film may further comprise at least one dark zone not comprising any microstructures, and shapes of said at least one dark zone and said at least one light-extraction zone may together form a luminous pattern of the luminous module.

It is thus possible to produce a large complex luminous pattern with a good light-intensity uniformity.

According to embodiments, the guiding sheet may be transparent and, for each portion of said at least one light-extraction zone, the microstructure density may be less than a maximum density, the maximum microstructure density being determined in such a way that the microstructures are invisible when no light rays are being injected by the light source. Here, the microstructure density may be the microstructure density on the first side or the microstructure density on the second side.

In other words, the maximum density is here a threshold value beyond which at least some of the microstructures may be visible to the naked eye. It will be noted that there is also a saturation density related to technical feasibility, i.e. the limit value feasible in a given microstructure-formation technology. It is thus possible to produce a large transparent luminous module with a good light-intensity uniformity.

According to embodiments, for the portions of said at least one light-extraction zone having different respective distances from the light-injection edge, the microstructure density on the first side may be a first increasing function of the distance between the portion and the light-injection edge, the first increasing function may have a maximum microstructure density in at least the portion furthest from the light-injection edge, and the microstructure density on the second side is a second increasing function of the distance between the portion and the light-injection edge. Here, the maximum microstructure density is determined in such a way that the microstructures are invisible when no light rays are being injected by the light source.

In addition, the first increasing function is different from the second increasing function. In other words, the microstructure density on the first side, from the injection edge to the portion furthest from this edge, varies according to a mathematical function or according to a computational law that is different from that of the microstructure density on the second side, again from the injection edge and with distance therefrom. By way of example, the microstructure density on the first side increases linearly as a function of the distance between the portion and the light-injection edge of the guiding sheet. On the other side, i.e. on the second side, the microstructure density may increase non-linearly, for example in tiers or according to a logarithmic law or an exponential law as a function of the distance between the portion and the light-injection edge of the guiding sheet.

It is thus possible to define a suitable arrangement of the microstructures on each of the two sides of the light-guiding sheet, in order to meet various requirements such as the uniformity and the luminous power of the light guide. The proposed light guide may thus be parametrized as required.

In addition, the second increasing function has a maximum microstructure density in at least the portion furthest from the light-injection edge that may be equal to the maximum microstructure density.

Thus, the maximum microstructure density is doubled through use of both sides, this making it possible to increase the size of the luminous module, or, at equal size, to increase the amount of light extracted.

In addition, the microstructure density on the second side may be zero in the portion furthest from the light-injection edge.

Thus, the dynamic light-extraction range is mainly defined by the first side. Furthermore, manufacture of such a luminous module is facilitated, since the portion of the second side of the film on which microstructures are formed is minimized.

In addition or as a variant, the first side may be oriented toward the outside of the luminous module and the second side may be oriented toward the inside of the luminous module.

Thus, the side that mainly defines the dynamic extraction range is oriented toward the outside of the luminous module, this maximizing the amount of light rays emitted toward the outside of the luminous module. The efficiency associated with the luminous module is thus improved.

According to embodiments, the film may be made of polycarbonate, PC, of polymethyl methacrylate, PMMA, of thermoplastic polyurethane, TPU, of polyethylene terephthalate, PET, or of silicone, and may have a thickness between 25 and 1000 microns, in particular between 50 and 1000 microns, and for example between 200 and 500 microns.

This thus makes it possible to produce a flexible guiding sheet, this facilitating its integration into any type of equipment.

A second aspect of the invention relates to a piece of automotive vehicle equipment comprising a luminous module according to the preceding claim.

### BRIEF DESCRIPTION OF DRAWINGS

Other features and advantages of the invention will become apparent on examining the following detailed description and the appended drawings, in which:

FIG. 1 illustrates a cross-sectional view of elements of a light guide for a luminous module according to embodiments of the invention;

FIG. 2 illustrates a front view of the elements of a light guide for a luminous module according to embodiments of the invention;

FIG. 3 illustrates a front view of the elements of a light guide for a luminous module according to embodiments of the invention;

FIG. 4 illustrates a three-dimensional view of a light-guide injecting assembly for a luminous module according to embodiments of the invention;

FIG. 5 illustrates a luminous pattern displayed on a guiding sheet of a luminous module according to embodiments of the invention;

FIG. 6 illustrates microstructure densities in portions of light-extraction zones of a luminous module according to embodiments of the invention;

FIG. 7 illustrates a plurality of views of a light guide of a luminous module according to embodiments of the invention; and

FIG. 8 illustrates a plurality of views of a light guide for a luminous module according to other embodiments of the invention.

### DETAILED DESCRIPTION OF THE INVENTION

The description focuses on the features that set apart the external device and the luminous module from those known in the prior art.

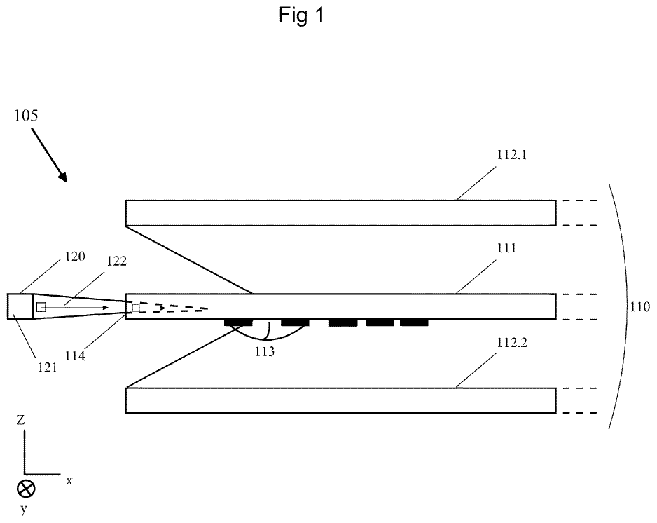

FIG. 1 shows elements of a light guide 105 of a luminous module according to embodiments of the invention.

The light guide 105 comprises a guiding sheet 110, which may be flexible, capable of receiving light rays through at least one light-injection edge 114 and of steering the light rays in a Z-direction substantially normal to a surface of the guiding sheet which thus extends in an X-Y plane in FIG. 1. By guiding sheet what is meant is a guiding optical element one of the spatial dimensions of which is much smaller than the other two spatial dimensions, smaller by one or more orders of magnitude for example. As illustrated in FIG. 1, the guiding sheet 110 considered here has a thickness along the Z-axis smaller by at least two orders of magnitude than its dimensions in the X-Y plane in which the guiding sheet 110 extends.

The guiding sheet 110 may comprise at its core a film 111 that may be flexible, that comprises the light-injection edge 114, that is capable of guiding the light rays in an overall X-direction, and that comprises a set of microstructures 113 capable of steering the light rays guided into the film 111 out of the flexible guiding sheet 110, and in particular in one or more directions substantially along the Z-axis.

The film 111 may be a substrate film made of polycarbonate, PC, of polymethyl methacrylate, PMMA, of thermoplastic polyurethane, TPU, of polyethylene terephthalate, PET, of silicone, or even of glass. The film 111 may have a thickness, that is a dimension along the Z-axis, of between 12 and 1000 microns. More precisely, the thickness of the film 111 may be between 25 and 1000 microns, in particular between 50 and 1000 microns, and for example between 200 and 500 microns. As a variant, it is the guiding sheet 110 that has a thickness of between 200 and 1000 microns.

The aforementioned materials, associated with a small thickness as described above, make it possible to obtain a flexible and transparent film 111. Other materials may be considered for the composition of the film 111. However, it is preferable, according to the invention, to provide deformable and transparent materials.

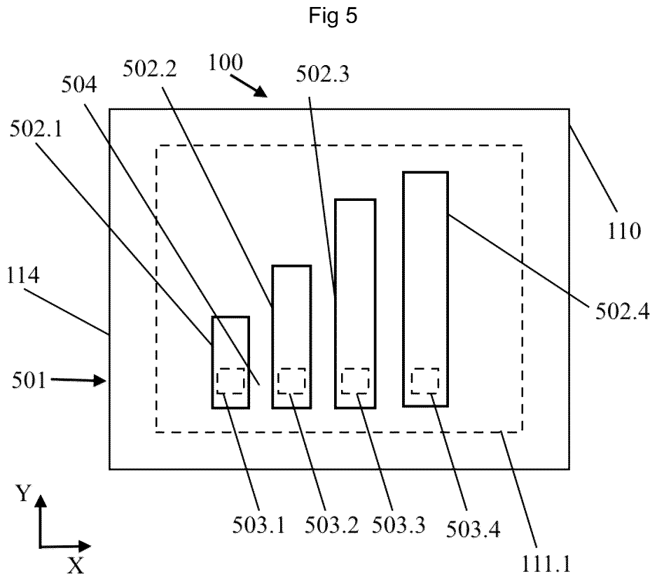

A thin coating of microstructures 113 may be created on one of the sides of the film 111, or in the film 111. According to the invention, microstructures 113 are formed on both sides of the film, as will be better understood on reading the description of FIG. 5 et seqq.

The microstructures are formed on the surface of the film and distributed so as to produce a luminous pattern. The luminous pattern is obtained using light-extraction zones, namely zones of the film 111 that contain microstructures 113. The luminous pattern may also comprise dark zones, namely zones of the film 111 containing no microstructures 113. The shapes and respective arrangements of the light-extraction zones and of the dark zones together form the luminous pattern. As a variant, the luminous pattern comprises only one light-extraction zone of a given shape.

By microstructures 113 what is meant is structures, or irregularities, in the flexible film that have at least one dimension smaller than a few microns. For example, the microstructures 113 may be of the order of 50 microns in diameter and 1 or 2 microns in height. The microstructures thus also cover nanoscale structures. Microstructures 113 of such sizes make it possible to ensure that the flexible film 111 is highly transparent. In particular, a transparency of the order of 97% may be obtained in practice through use of microstructures 113. As a variant, the guiding sheet may be semi-transparent.

The microstructures are capable of redirecting the light injected into the light guide in one or more directions different from the direction of injection along the X-axis. In particular, at least some of the redirected light rays are redirected in a direction substantially parallel to the Z-axis, and in particular in a direction directed toward the outside of the luminous module 100. In practice, such microstructures are capable of redirecting the guided light rays in all directions of space, in a Lambertian fashion.

No restrictions are placed on the way in which the microstructures 113 are formed on the side of the film 111. The microstructures 113 may be obtained by adding or subtracting material from the flexible film.

For example, the microstructures may be obtained by embossing by applying a roller having irregularities to mechanically print microstructures on the surface of the film 111. As a variant, the microstructures 113 may be obtained by irradiation, for example with UV rays, or by baking a polymer making contact with a mold, a roller or any other surface comprising irregularities capable of forming microstructures of complementary shape.

As another variant, the microstructures 113 are formed in locations where a coating of the flexible film, made of a material having a low refractive index, is removed from the flexible film, so as to form microstructures by removing material. In this case, the microstructures are holes or gaps. Optionally and in a complementary manner, additional (prismatic, reflecting, diffracting or diffusing) surface or bulk elements may be added in the holes or gaps to form the microstructures 113.

The microstructures 113 may be obtained by treating the surface of the film 111, in which case they are of the same material as the film 111 or correspond to an absence of material of the film 111. Such a treatment may be achieved by mechanical or laser scribing, laser ablation, sandblasting, exposure to radiation, chemical treatment or any other treatment making it possible to obtain irregularities in a controlled manner on the side of the film 111.

As a variant or in a complementary manner, the microstructures 113 are exogenous elements to the film added to the side of the film 111.

The coating of microstructures 113 may in particular have a thickness along the Z-axis smaller than 20 microns.

As detailed below, the density of the microstructures 113 may vary in the light-extraction zones as a function of their distance from the light-injection edge 114.

By “pattern” what is meant is any predefined spatial distribution of the luminous intensity emitted by the luminous module. In particular, reference is made here to a two-dimensional or one-dimensional pattern. A pattern may thus comprise a uniform distribution of light over the entire guiding sheet, in which case a light-extraction zone extends over the entire guiding sheet. The pattern may also comprise a two-dimensional shape or symbol obtained by contrast between the light-extraction zones and the dark zones of the guiding sheet 110. The pattern may also comprise a plurality of shapes or symbols. Alternatively, a pattern covers a predefined spatial distribution of luminous intensity that does not cause any general shape to appear, such as a distribution resulting in a cloud of luminous dots.

The flexible guiding sheet 110 may further comprise one or two optional protective layers 112.1 and 112.2, which allow the film 111 to be mechanically protected. Furthermore, at least one of the protective layers 112.1 and 112.2 may comprise an anti-UV treatment, preferably the protective layer 112.1 through which the light rays steered by the microstructures 113 are emitted, making it possible to protect the film against UV rays, once the microstructures 113 have been created. Without such UV protection, the pattern projected by the guiding sheet 110 is likely to deteriorate over time, in particular when exposed to sunlight.

The film 111 and the protective layers 112.1 and 112.2 have been shown spaced apart in FIG. 1 purely by way of illustration. It will be understood, however, that the protective layers 112.1 and 112.2 may be attached to the film 111, in particular by lamination.

The light rays propagate through the film 111 by total internal reflection by virtue of the difference between the refractive index of the film 111 and the refractive index of a layer of glue or adhesive applied to at least one side of the flexible film.

The film 111 may be joined to the protective layers 112.1 and 112.2 by adhesive bonding. Specifically, a layer of adhesive is placed between the film 111 and each protective layer 112.1 and 112.2, on both sides of the film in order to cause the protective layers to adhere to the film 111.

The chosen adhesive is transparent and has a refractive index different from, and in particular less than, that of the film so as to allow total internal reflection in the film 111. For example, the adhesive may comprise silicone or acrylic. In other words, because of the difference in refractive indices, the light rays propagating through the film 111 undergo total reflection when they encounter the interface between the film 111 and the adhesive layer with an angle of incidence smaller than normal incidence. Thus, the guiding sheet is capable of guiding light by total internal reflection of the light, for example from an entry zone, here of the injection edge 114, to an exit zone.

Since the guiding sheet 110 may be flexible, it is not necessarily contained in a plane but may be curved, depending on the position in which it is placed and the mechanical constraints applied to it.

The light guide 105 illustrated in FIG. 1 also comprises an injecting assembly 120 comprising a plurality of light-injecting elements, described with reference to the following figures, the assembly 120 being capable of distributing light to the guiding sheet 110 at various positions along the Y-axis, along the light-injection edge 114. Light is injected, at each position along the Y-axis, in a direction substantially parallel to the X-axis.

The injecting assembly 120 comprises an entrance surface 121 of rectangular or square cross section in FIG. 1. However, the assembly 120 may have an entrance surface having a cross section of different shape.

In FIG. 1, the injecting assembly 120 shown has an exit surface 122 extending in the Y-direction and placed facing the light-injection edge 114. It will be understood on reading the description of the following figures that the exit surface 122 and the light-injection edge 114 are one and the same, the flexible film 111 and the injecting assembly 120 forming a single part.

The injecting assembly 120 further comprises, at one end of the injecting assembly 120, the entrance surface 121 capable of receiving light rays from a light source outside the light guide 105 (which light source has not been shown in FIG. 1), and the injecting assembly 120 is capable of guiding light longitudinally along the Y-axis while distributing it to the exit surface 122. The distribution of light by the exit surface 122 will be better understood in the light of the description of the following figures.

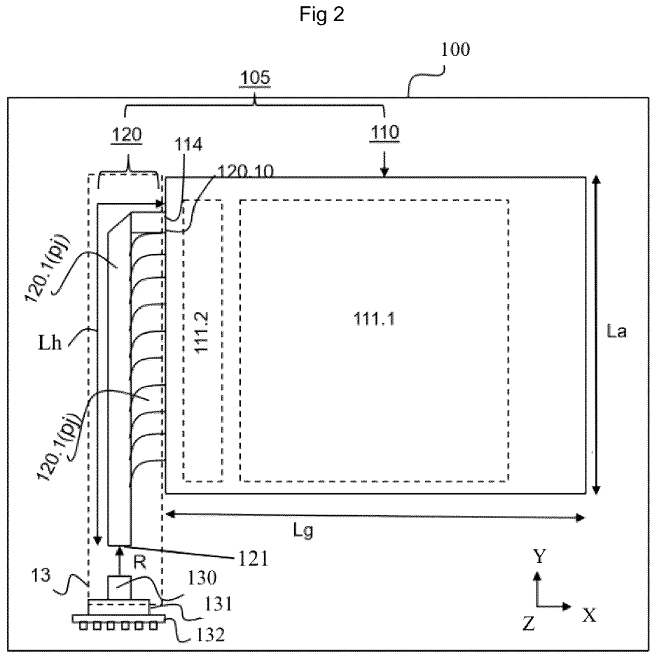

FIG. 2 shows elements of a luminous module 100 comprising a light guide 105 with an assembly 120 of injecting elements and a flexible guiding sheet 110, and a light source 130.

Depending on the distribution of the microstructures 113, the guiding sheet 110, or more precisely the film 111, may comprise a mixing zone 111.2 and a luminous emission zone 111.1, the luminous zone comprising at least one light-extraction zone provided with microstructures 113, and optionally one or more dark zones, so as to produce a luminous pattern in the luminous emission zone 111.1. The mixing zone 111.2 is placed upstream of the light-emission zone in the direction of propagation of the light rays. The luminous emission zone 111.1 is integrated into a region 1110.

The light injected into the light-guiding sheet 110 via the injection edge 114 is mixed in the mixing zone 111.2 in order to obtain a better luminous uniformity. The light then propagates into the luminous emission zone 111.1 in which the light exits from the light-guiding sheet 110 in the Z-direction.

More generally, the mixing zone 111.2 is a zone of the flexible guiding sheet that does not comprise the luminous pattern emitted by the flexible guiding sheet 110, the mixing function of the zone 111.2 being optional.

The assembly 120 of injecting elements 120.1 is capable of injecting light rays generated by the source 130 into the injection edge 114 toward the mixing zone 111.2. FIG. 2 shows a single injecting assembly 120 by way of illustration.

It will be noted that the light guide 105 may comprise a plurality of injecting assemblies 120 per injection edge 114, each injecting assembly 120 being arranged at a given set of Y-positions on the injection edge 114. Each injecting assembly 120 is thus configured to illuminate a different region 1110 in the light-guiding sheet. Below, a single injecting assembly 120 per injection edge 114 will be considered, by way of illustration.

The assembly 120 comprises a plurality of light-injecting elements 120.1. The assembly 120 may in particular comprise between three and ten injecting elements 120.1. In the non-limiting example of FIG. 2, the light guide 105 comprises an assembly 120 with ten injecting elements. For the sake of clarity, only two light-injecting elements 120.1 have been designated by a reference.

The assembly 120 is coupled to at least one light source 130 such that the light rays R emitted by said light source are received by each of the light-injecting elements 121.

Given that the light-injecting elements 121 are obtained, by cutting, from the same material as the flexible film 111, the light rays R will propagate by total internal reflection through the light-injecting elements 120.1 and deliver light to the light-guiding sheet, which is adjacent to and integral with the light-injecting elements 120.1, and the light will thus illuminate the one or more light-extraction zones of the light-guiding sheet 110.

The superposition of the light-injecting elements 120.1 forming the assembly 120 may thus form a coupling bar, or light bar, configured to receive the light rays generated by the light source 130 and to propagate them into the light-guiding sheet 110. The assembly 120 may be of square or rectangular cross section.

No restrictions are placed on the light source 130, which may be in any light-source technology. For example, the light source 130 may be an electroluminescent element, such as an LED for example, mounted on a substrate 131. A heat-dissipating element 132 may moreover be arranged below the substrate 131.

The light source 130 may be capable of generating light in a wavelength interval. Such an interval may be centered on a visible color, in order to generate colored light, for example blue, red or green light. As a variant, the light source 130 may emit light rays across the entire interval of wavelengths visible to the human eye, so as to generate white light. The light source 130 may be controlled by a control element (not shown). As a variant, the light source 130 is not arranged directly facing an entrance surface 121 of the injecting element 120, but the luminous module 100 further comprises an optical fiber placed between the source 130 and the injecting assembly 120, this allowing the source 130 to be located away from light guide 105.

It is thus possible to inject light at various longitudinal positions along the Y-axis of the injection edge 114.

The guiding sheet 110 may have a width La along the Y-axis and a length Lg along the X-axis. The light guide 105 may be cut from a roll of the same material as the film 111 and the injecting elements 120, the roll extending along the X-axis and having the same width La as the light guide 105.

The references (pj) designate injection positions of index j, each injection position of index j corresponding to one interval of positions along the Y-axis of injection into the injection edge 114, j varying between 1 and N, N being the number of injecting elements 120.1 in the injecting assembly 120 (i.e. N=10 in the example considered so far).

The luminous module 100 thus comprises the light guide 105, comprising the flexible guiding sheet 110 and the injecting assembly 120, and the light source 130.

The assembly 120 and the light source 130 may be contained in a portion 13 of the luminous module 100 that is unable to be viewed. Such a portion may be hidden whereas the luminous emission zone 111.1 is in contrast able to be viewed from outside a piece of equipment comprising the light guide 105.

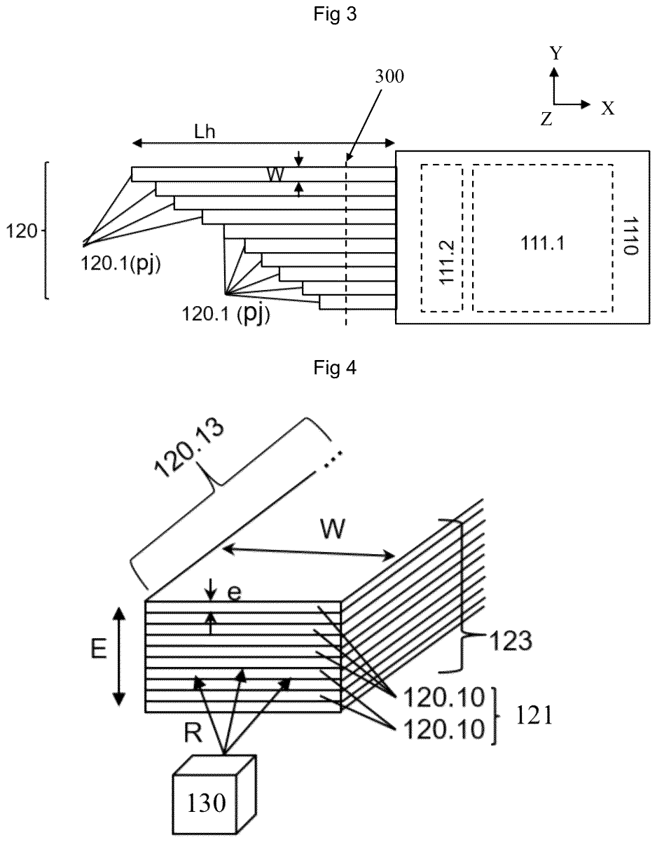

FIG. 3 illustrates the light guide of FIG. 2 with the light-injecting elements 120.1 of the injecting assembly 120 unfolded. In FIG. 3, each injecting element 120.1 has a respective length Lh and a width W.

For the sake of clarity of FIG. 3, only the length Lh and the width W of the longest injecting element 120 have been designated by references. The lengths Lh of the other injecting elements 120 are less than the length Lh of the longest injecting element. In contrast, the widths W of all the injecting elements 120.1 may be equal.

By way of non-limiting example, the length Lh of the longest injecting element 120.1 is between 100 and 500 millimeters. Likewise, the width W may be between 1 and 20 mm.

A folding position 300 is moreover indicated in FIG. 3, each injecting element 120.1 being capable of being folded at the folding position 300 so that the injecting elements 120.1 superpose to form the assembly 120. The respective lengths Lh of the injecting elements are determined, based on the folding position and on the respective Y-positions of the injecting elements, so that their ends together form the injection surface 121.

FIG. 4 illustrates a three-dimensional view of the assembly 120 and of the light source 130, of a luminous module 100 according to embodiments of the invention.

As illustrated in FIG. 4, each light-injecting element 120.1 has a thickness e. The thickness e corresponds to the thickness of the light guide 105, i.e. of the film 111. The light-injecting element 120.1 has two ends 120.10, one of which, illustrated in FIG. 2, is integral with the guiding sheet 110 and the other of which, illustrated in FIG. 4, is capable of being placed facing the light source 130. The light rays emitted by the light source 130 enter through one end 120.10, called the first end, and are transmitted to the other end 120.10, called the second end, and then to the light-guiding sheet 110 via the light-injection edge 114, which is coincident with the second ends 120.10 of the injecting elements 120.1.

It will be noted that, during the process of manufacture of the light guide 105, the injecting elements 120.1 and the light-guiding sheet 110 may be manufactured from a roll of material, engraved with a given pattern, and then cut with a blade or cutters to separate the light guide 105 from the rest of the roller and to separate the various injecting elements 120.1 along the X-axis and thus form the various injecting elements 120.1, before they are folded at the folding position 300.

Thus, the light-injecting elements 120.1 remain attached to the guiding sheet 110 at their second ends 120.10.

The respective lengths Lh of the injecting elements 120.1 are such that the first ends 120.10 facing the light source 130 coincide to form the injection surface 121 of the assembly.

The injection surface 121 thus has a thickness E equal to the sum of the thicknesses e of the injecting elements 120.1.

FIG. 5 shows a guiding sheet 110 of a light guide of a luminous module 100 according to embodiments of the invention.

The injecting assembly 120 has not been shown in FIG. 5, for the sake of simplicity.

A luminous pattern is formed by four light-extraction zones 502.1, 502.2, 502.3 and 502.4 that contain microstructures (not shown in FIG. 5), and a dark zone 504 that does not contain any microstructures. The dark zone 504 and the light-extraction zones 502.1, 502.2, 502.3 and 502.4 are complementary and together form the luminous pattern in the luminous emission zone 111.1.

One position 501 of injection into the light-injection edge 114 has been shown in FIG. 5. The injection position 501 corresponds to a position along the Y-axis facing which are located one portion 503.1 of the first light-extraction zone 502.1, one portion 503.2 of the second light-extraction zone 502.2, one portion 503.3 of the third light-extraction zone 502.3 and one portion 503.4 of the fourth light-extraction zone 502.4. Preferably, the injection position 501 is a section 501 comprising an interval of Y-positions. It may for example be a question of a set of Y-positions corresponding to one injecting element 120.1 among the assembly 120 of injecting elements 120.1.

No restrictions are placed on each of the portions 503.1 to 503.4, which may be any area of size greater than the dimensions of the microstructures, and preferably at least ten times greater than the dimensions of the microstructures, so as to be able to determine a microstructure density therein.

The light rays injected at the injection position 501, and possibly light rays injected in proximity to the injection position 501, i.e. at two close-by Y-positions, are guided through the guiding sheet 110, and the light rays are gradually extracted from the guiding sheet 110 by the portion 503.1, then by the portion 503.2, then by the portion 503.3, then by the portion 503.4.

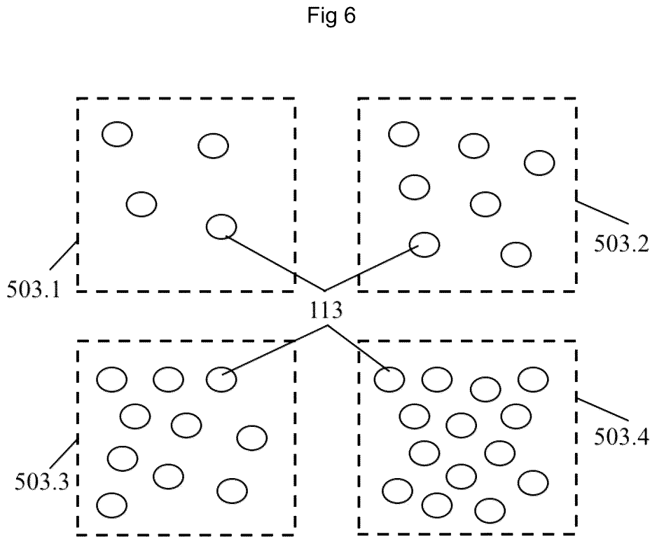

In order to make it possible for the luminous intensity in each of the portions 503.1 to 503.4 to remain similar, and consequently to allow a luminous pattern with a uniform luminous intensity to be achieved, the respective microstructure densities within the portions 503.1 to 503.4 may vary as illustrated in FIG. 6.

In particular, the microstructure density in a given portion of a light-extraction zone depends on a distance between the portion and the light-injection edge 114.

FIG. 6 illustrates the microstructure densities in the portions of the light-extraction zones illustrated in FIG. 5.

As shown in FIG. 6, the density of the microstructures 113 in a given portion varies positively with (or is an increasing function of) the distance between the portion and the light-injection edge 114. Specifically, the quantity of light rays reaching the portion 503.4 is smaller than the quantity reaching the portion 503.1. To compensate for this, the microstructure density in portion 503.4 is greater than in portion 503.1.

No restrictions are placed on the increasing function relating the distance from the light-injection edge 114 to the density of microstructures 113. Such a function depends on the desired brightness of the luminous pattern, on intrinsic characteristics of the light guide 110 and on the light source 130.

In the example illustrated in FIG. 5, the X-positions of the portions 503.1 to 503.4 are non-consecutive. The portions 503.1 to 503.4 are in particular separated by the dark zone 504 of the luminous pattern.

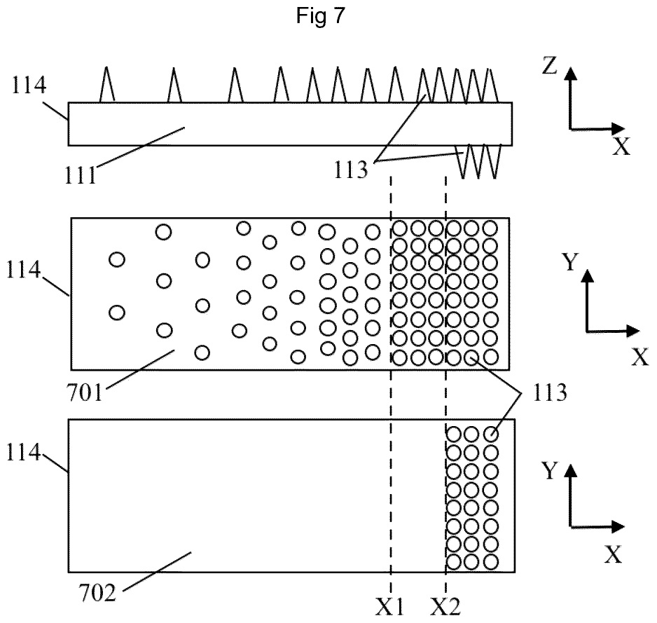

However, in particular when the luminous pattern comprises only a single light-extraction zone (and therefore no dark zone), portions of the single light-extraction zone having consecutive positions may be considered when describing the variation in the densities of the microstructures 113. Such an example is used to describe FIG. 7 below.

As explained in the introduction, the density of the microstructures 113 is limited, i.e. it is not possible to increase the density of the microstructures 113 as a function of the distance from the light-injection edge 113 indefinitely. As a result:
either the size of the guiding sheet is limited if it is desired to preserve a uniform pattern;
or the size of the guiding sheet is not limited but the density of the microstructures saturates and the luminous pattern no longer appears uniform. Specifically, the luminous intensities of the portions of the light-extraction zone beyond the X-position where the density saturates, are lower than the luminous intensities before saturation.

FIG. 7 shows a side view, a top view and a bottom view of a film 111 of a guiding sheet of a luminous module according to embodiments of the invention.

In accordance with the invention, microstructures 113 are formed both on a top side 701 and on a bottom side 702 of the guiding sheet 110.

The microstructures 113, irrespectively of whether they are formed on the top side 701 or on the bottom side 702, are capable of steering light at least in a direction substantially along the Z-axis, outward from the top side 701, the top side being oriented toward the outside of the luminous module 100.

Thus, the amount of light extracted in each interval of X-positions of the guiding sheet depends on the sum of the density of the microstructures on the top side 701 and of the density of the microstructures 113 on the bottom side, in the interval of X-positions. Thus, denoting the maximum density of microstructures 113 on a given surface dmax, the sum of the densities in each interval of X-positions may vary between 0 and 2*dmax, instead of varying between 0 and dmax as in the prior art.

The sum of the densities of microstructures 113 on the top side 701 and on the bottom side 702, for a given portion of the light-extraction zone, is an increasing function of the distance between the light-injection edge 114 and said portion. In other words, for any pair of facing portions of a given section of the injection edge, the sum of the densities of microstructures on the two sides of the portion closest to the injection edge is less than the same sum in the portion furthest away.

It is thus possible:
to increase the amount of light extracted for a given size of guiding sheet 110, while displaying a luminous pattern with a uniform luminous-intensity distribution;
to increase the size of the guiding sheet 110 while displaying a luminous pattern with a uniform brightness.

The maximum density dmax may correspond to the density below which the microstructures 113 are invisible when no light rays are being injected into the guiding sheet 110. Such a maximum density is advantageous when a transparent guiding sheet 110 is used.

As a variant, the maximum density may correspond to a density above which the microstructures 113 make contact with one another. The maximum density may also be set by the manufacturing process of the light guide 105.

In the example of FIG. 7, the density of the microstructures 113 on the top side increases with the distance from the light-injection edge, until saturation for a certain value of X, denoted X1. Beyond the saturation value X1, microstructures 113 may be formed on the bottom side 702, so that the sum of the densities on both sides continues to increase with distance from the light-injection edge. As a variant, as shown in FIG. 7, the microstructures are formed on the bottom side from a value X2, greater than X1.

As in FIG. 5, the light-extraction zone may be divided into portions. Regardless of the division into portions used, the sum of the microstructure densities on the top and bottom sides of a portion is an increasing function of the distance of the portion from the light-injection edge 114. In other words, the further a portion is from the light-injection edge 114, the greater the sum of the densities on its bottom and top sides.

As shown in FIG. 7, the bottom side 701 comprises only microstructures in the portion furthest from the injection edge, i.e. in the portion beyond X2. The portion between X1 and X2 is a portion of the top side 701 in which the microstructure density is maximum, but in this portion the bottom side still does not comprise any microstructures.

It will be noted that, in FIG. 7, the sum of the microstructure densities increases continuously because a single extraction zone, not interrupted by one or more dark zones, is shown. However, the invention also applies to luminous patterns containing dark zones, and the increase in the density of the microstructures as a function of the distance from the light-injection edge then applies only to portions of light-extraction zones, and not to the dark zones, which contain no microstructures.

Distributions of the microstructures 113 other than those shown in FIG. 7 are conceivable within the scope of the invention.

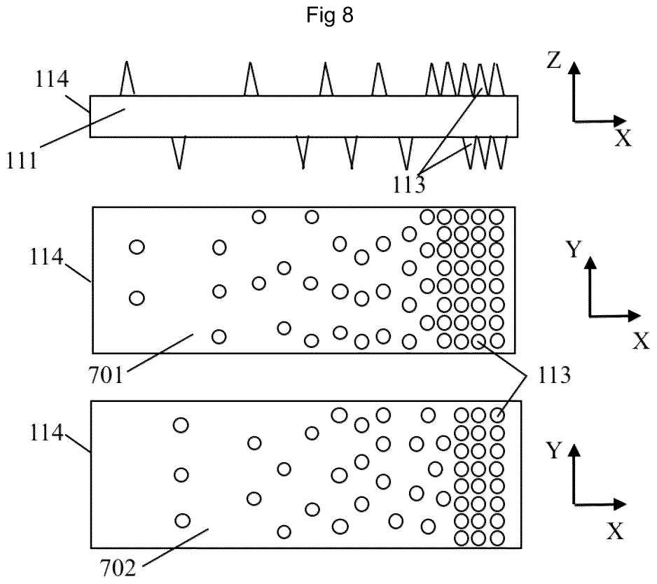

For example, FIG. 8 shows a side view, a top view and a bottom view of a film 111 of a guiding sheet of a luminous module according to embodiments of the invention, with a distribution of microstructures 113 different from the distribution shown in FIG. 7.

In the distribution of FIG. 8, the microstructure densities increase with distance from the light-injection edge 114 on each of the top and bottom sides 701, 702. The sum of the densities therefore also increases with distance from the light-injection edge 114.

In the example of FIG. 8, whatever the portions of said at least one light-extraction zone, the microstructure density on the top side 701 in a portion is a first increasing function of the distance of the portion from the light-injection edge 114. Likewise, the microstructure density on the bottom side 702 in a portion is a second increasing function of the distance of the portion from the light-injection edge. As shown in FIG. 8, the first and second functions may be different. The function corresponding to the sum of the densities of the microstructures on the top and bottom sides 701, 702 is thus a sum of the first function and of the second function, which is also increasing.

The present invention is not limited to the embodiments described above by way of example, but extends to other variants.

What is claimed is:

1. A luminous module comprising:
a light guide includes a sheet for guiding light, the light guiding sheet being configured to receive light rays via at least one light-injection edge, and to reflect the light rays in a direction substantially normal to the guiding sheet, and at least one injecting assembly configured to receive light rays from an entrance surface and to guide the light rays so as to inject them into the light-injection edge of the light guiding sheet;
a light source arranged so as to inject light rays into the entrance surface of the at least one injecting assembly;
wherein the guiding sheet includes a film, the film includes at least one light-extraction zone including microstructures capable of redirecting the light injected into the flexible guiding sheet at least in the substantially normal direction;
wherein the film includes microstructures on a first side of the film and on a second side of the film;
wherein, for each portion among portions of the light-extraction zone having different respective distances from the light-injection edge, a sum of a microstructure density on the first side in the portion and of a microstructure density on the second side in the portion, is an increasing function of the distance between the portion and the light-injection edge of the guiding sheet.

2. The luminous module as claimed in claim 1, the portions of the light-extraction zone facing a same given section of the light-injection edge.

3. The luminous module as claimed in claim 1, wherein a shape of the at least one light-extraction zone forms a luminous pattern of the luminous module.

4. The luminous module as claimed in claim 1, wherein the film includes at least one dark zone that does not include any microstructures, and wherein shapes of the at least one dark zone and the at least one light-extraction zone together form a luminous pattern of the luminous module.

5. The luminous module as claimed in claim 1, the guiding sheet being transparent and wherein, for each portion of the at least one light-extraction zone, the microstructure density on the first side or the microstructure density on the second side is less than or equal to a maximum density, the maximum microstructure density being determined in such a way that the microstructures are invisible when no light rays are being injected by the light source.

6. The luminous module as claimed in claim 1, wherein for the portions of the at least one light-extraction zone having different respective distances from the light-injection edge, the microstructure density on the first side is a first increasing function of the distance between the portion and the light-injection edge, wherein the first increasing function has a maximum microstructure density in at least the portion furthest from the light-injection edge, and wherein the microstructure density on the second side is a second increasing function of the distance between the portion and the light-injection edge, the maximum microstructure density being determined in such a way that the microstructures are invisible when no light rays are being injected by the light source.

7. The luminous module as claimed in claim 6, wherein the first increasing function is different from the second increasing function.

8. The luminous module as claimed in claim 6, wherein the second increasing function has a maximum microstructure density in at least the portion furthest from the light-injection edge.

9. The luminous module as claimed in claim 8, wherein the microstructure density on the second side is zero in portions of the light-extraction zone other than the portion furthest from the light-injection edge.

10. The luminous module as claimed in claim 5, wherein the first side is oriented toward the outside of the luminous module and the second side is oriented toward the inside of the luminous module.

11. The luminous module as claimed in claim 1, wherein the film is made of polycarbonate, PC, of polymethyl methacrylate, PMMA, of thermoplastic polyurethane, TPU, of polyethylene terephthalate, PET, or of silicone, and has a thickness between 50 and 1000 microns, and for example between 200 and 500 microns.

12. A piece of automotive vehicle equipment comprising a luminous module, wherein the luminous module includes a light guide including a sheet for guiding light, the light guiding sheet being configured to receive light rays via at least one light-injection edge, and to reflect the light rays in a direction substantially normal to the guiding sheet, and at least one injecting assembly configured to receive light rays from an entrance surface and to guide the light rays so as to inject them into the light-injection edge of the light guiding sheet, a light source arranged so as to inject light rays into the entrance surface of the at least one injecting assembly, wherein the guiding sheet includes a film, the film includes at least one light-extraction zone including microstructures capable of redirecting the light injected into the flexible guiding sheet at least in the substantially normal direction, wherein the film includes microstructures on a first side of the film and on a second side of the film, wherein, for each portion among portions of the light-extraction zone having different respective distances from the light-injection edge, a sum of a microstructure density on the first side in the portion and of a microstructure density on the second side in the portion, is an increasing function of the distance between the portion and the light-injection edge of the guiding sheet.
